(19) United States
(12) Patent Application Publication
(10) Pub. No.: US 2004/0250125 A1
(43) Pub. Date: Dec. 9, 2004

(54) Security context maintenance within a distributed environment

(75) Inventors: Philippe A. Janson, Wadenswil (CH); Anthony Joseph Nadalin, Austin, TX (US); Nataraj Nagaratnam, Morrisville, NC (US)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 10/443,371

(22) Filed: May 22, 2003

(51) Int. Cl. H04L 9/00

(52) U.S. Cl. 713/201

(57) ABSTRACT

The present invention is a method and apparatus for maintaining security context data within a distributed environment. The method can include the step of identifying a context reference to the security context data within an application request. The security context data can be retrieved from a remote source in the distributed environment by reference to the context reference. Subsequently, the retrieved security context data can be passed to security logic coupled to a hosted application targeted by the application request. Importantly, for each application server and each application service through which the reference can pass, the context can be augmented as the request traverses through services and servers.

### BACKGROUND OF THE INVENTION

1. Statement of the Technical Field

The present invention relates to the field of context management, and more particularly to the maintenance of contextual access data for individual application sessions in a distributed application environment.

2. Description of the Related Art

Context management refers to the management of shared application data across different applications in a computing environment. Context management systems can streamline, simplify and coordinate the process of accessing stored shared data in multiple disparate applications. In this regard, in the absence of a context management system, shared data which otherwise could be shared between two or more different applications in the computing environment, must be repetitively provided to each of the different applications. Consequently, context management systems greatly streamline the task of interoperability in respect to the different applications.

Notably, the process of context management has proven to be a challenging endeavor. Specifically, different applications often are produced and provided by different application vendors. Furthermore, different applications may incorporate different and unique user interfaces. In either or both cases, a different data entry procedure can be required in order to satisfy the various nuances of each interface required to interoperate with the respective applications.

To address the foregoing difficulties in sharing application data across application boundaries, some have developed context management technologies, such as the technology described in United States Patent Publication No. US 2002/0107875 entitled CONTEXT MANAGEMENT WITH AUDIT CAPABILITY and published on behalf of Robert Seliger and David Fusari (the “Seliger publication”). In the Seliger publication, a context manager can be provided which can support context-enabled applications and which further can pass context data between two applications and another.

As defined in the Seliger publication, “context data” refers to “information indicative of a condition or identity associated with users, applications, stored records, or any other information that facilitates or enables performance of inter-application or inter-platform functionality in a context management environment.” In this regard, “[t]he context data may contain data useful for accessing data relating to or identifying an attribute of a user, machine, application, customer, or patient.”

Security context management represents the narrower case of managing authentication data across multiple application contexts. In particular, some in the technical field have defined a “security context” to include “a representation of [a] user's identity as well as any authorization information associated therewith.” See e.g. United States Patent Publication No. US 2002/0073320 entitled AGGREGATED AUTHENTICATED IDENTITY APPARATUS AND METHOD THEREFOR. Typically, security context management infers the sharing of user identification data across application boundaries so as to avoid the requirement of repetitive manual log-in procedures. Single sign-on technology represents one such security context management endeavor.

In any case, as described in the Seliger publication, “[B]y carrying out certain actions, referred to as “context gestures”, a user using a context-managed environment causes context data to be generated and transmitted through the context manager.” More particularly, “context gestures” take the form of a user indicating to the environment when to change contexts from one application to the next. In this regard, the notion of “context” refers to the idea of task switching from one application to another in a computing environment. By managing common data through a context manager, the context in which the context gestures are carried out may be communicated from a prior application to a current application in order to simplify the work of the user.

Hence, through the operation of a context manager, a current application can “know” in what context the user had been working at the time of the shift from a prior application to the current application. This “look-ahead” functionality represents a shortcut that can shift some of the burden of cross-application work from the user to the context manager. Nevertheless, as applied specifically to security context management in a distributed environment, the centralized management of shared knowledge of authentication identity alone cannot suffice for distributed multi-protocol, multi-application environments such as those encountered in the modern Grid architecture.

In particular, security context data, as well as application contextual information cannot be maintained at present across disparate protocols between application services operating in different computing environments and processes. Thus, when security context information crosses application, process and protocol boundaries, the security context information can become lost. Without security context information, however, correlating context data in a distributed environment such as a Grid can inhibit audit control of user authentication.

### SUMMARY OF THE INVENTION

The present invention is a method and apparatus for maintaining security context data within a distributed environment. In one aspect of the invention, the method can include the step of identifying a context reference to the security context data within an application request. The security context data can be retrieved from a remote source in the distributed environment by reference to the context reference. Subsequently, the retrieved security context data can be passed to security logic coupled to a hosted application targeted by the application request.

Notably, the security context data in the remote source can be augmented with access data produced in consequence of accessing the hosted application targeted by the application request. Additionally, the retrieved security context data can be used to control access to the hosted application. In any case, in a preferred embodiment the retrieving step itself can include the step of invoking a remotely positioned context manager and calling a method in the remotely positioned context manager with the reference in order to retrieve the security context data.

The present invention can further include a process for configuring a distributed environment to operate in accordance with the foregoing method. Specifically, a method for maintaining security context in a distributed environment can include programming at least one application server in the distributed environment to identify security context references within application requests received in the application server. A context manager in the distributed environment can be coupled to the programmed application server. Finally, the programmed application server can be configured to retrieve security context corresponding to identified security context references through the coupled context manager.

The configuration process can be applied to multiple variations of a distributed application environment, including a basic application server infrastructure, and a Web services distribution infrastructure. In a preferred aspect of the invention, the configuration process can be applied to a Grid environment. In this regard, the method of the invention can include the step of disposing the context manager in a remotely positioned service host. More particularly, the method of the invention can include the step of wrapping the context manager to form a grid service; and, deploying the wrapped context manager in a grid host.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of a distributed, multi-protocol environment configured to maintain security context information across protocol and application boundaries in accordance with the inventive arrangements; and,

FIG. 2 is a flow chart illustrating a process for maintaining security context within application hosts in the distributed, multi-protocol environment of FIG. 1.

### DETAILED DESCRIPTION OF THE PREFERRED EMBODIMENTS

The present invention is a method and apparatus for security context maintenance within a distributed environment. In accordance with the present invention, references to security context can be included within protocol requests between application entities in the distributed environment. In this regard, security context can refer both to authentication data, audit trail data, and optionally, other types of data including strength of authentication. Upon receiving a protocol request in an application component, the reference can be used to retrieve the security context from a remote source within the distributed environment. Based upon the retrieved security context, security logic can manage access to the application component including the verification of the ability of an end-user to access the application component. Furthermore, an application audit trail can be properly maintained based upon the retrieved security context.

In this way, by not requiring the direct transmission of security context from application to application, over specific protocols that may be limited by the type of information which the protocol can carry, the security context can be maintained across application and protocol boundaries by using a context reference identifier within the protocol context. Additionally, the security context can be maintained throughout the entire distributed application request flow, from the first application component in the distributed environment, for example a Web server, to the last application component in the distributed environment, for instance a legacy application. In this way, different security decision points within the flow can act upon the security context without regard to different protocol and application boundaries.

Notably, the security context maintenance technology of the present invention can be incorporated into the application infrastructure of the distributed environment. As the skilled artisan will recognize, the application infrastructure can range from a simple application server hosting one or more application components, to multiple application servers hosting multiple applications in a distributed fashion across either a single or multiprotocol based network, to a highly distributed system of Web services, such as that of the emerging Grid technologies. In this regard, security context can be maintained across different grid services in the Grid environment through the use of a security context manager which can be wrapped within a grid service.

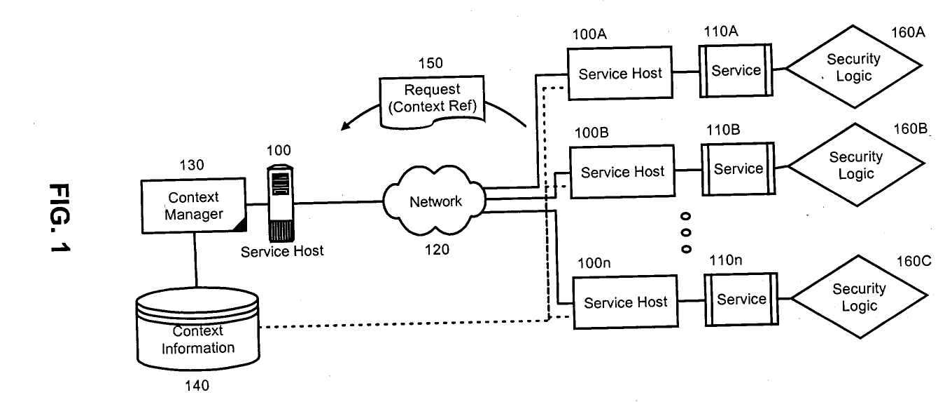

FIG. 1 is a schematic illustration of a distributed, multi-protocol environment configured to maintain security context information across protocol and application boundaries in accordance with the inventive arrangements. As it will be recognized by the skilled artisan, the environment illustrated in FIG. 1 can model both a traditional distributed application component environment such as a Web services environment, or a more advanced Grid environment. Nevertheless, it is to be recognized that the invention is not so limited to merely a Web services or Grid environment and other distributed environments are contemplated by the invention described herein, including, for instance, one or more application servers hosting one or more applications or application components through which request flows can pass.

In any event, as shown in FIG. 1, the exemplary environment can include one or more service hosts 100A, 100B, 100n in which one or more services 110A, 110B, 110n can be hosted, respectively. Each service can be a stand-alone application, or application component, such as would be the case where each service 110A, 110B, 110n included a Web service, or grid service. Each service host 100A, 100B, 100n can be incorporated as part of a service hosting infrastructure, such as an application server. To that end, the service hosts 100A, 100B, 100n can be communicatively coupled to one another over a computer communications network 120, for instance an intranet, or a global internet such as the ubiquitous Internet.

Importantly, a security context manager 130 can be included within yet another service host 100, also coupled to the data communications network 120. The context manager 130 can include a data store 140 of context information. In this regard, the context manager 130 can retrieve contextual access data for individual application sessions or users. The contextual access data in the data store 140 can include, by way of example, not only user or session authentication data, but also an audit trail of application access throughout the request flow from service 100A, 100B, 100n to service 100A, 100B, 100n. In any case, each of the service hosts 100A, 100B, 100n can be configured to access the context manager 130 as need be to access the stored contextual access data in the data store 140.

In operation, as requests 150 are issued to access elements of different services 100A, 100B, 100n in the distributed environment, references to the stored contextual access data in the data store 140 can be passed within the request itself. Importantly, the contextual access data need not be passed directly from service host 100A, 100B, 100n to service host 100A, 100B, 100n in the course of the request flow. Rather, merely a reference to the contextual access data need be included in any one request 150. Upon receiving a request 150 incorporating a reference to the contextual access data, the service host 100A, 100B, 100n can retrieve the contextual access data from the data store 140 through the context manager 130. More particularly, whenever a service host 100A, 100B, 100n receives a request 150, the service host 100A, 100B, 100n can append contextual access data to the request 150 based upon the policies associated with the service host 100A, 100B, 100n such as whether or not to add contextual access data, and more importantly, what contextual access data to add to the request.

Once the contextual access data has been retrieved, the data can be provided to the corresponding hosted service 110A, 110B, 110n for use in the operation of associated security logic 160A, 160B, 160n, or in logging an audit trail across the request flow. Thus, flowing the context reference along with a request flow, over one or more protocol and application boundaries permits the contextual access data to remain available for use at every security decision point in the environment. In this way, the security enforcement points can use the contextual access data to properly authorize access to an associated application or application component, despite the disparate nature of different protocols or applications in the environment.

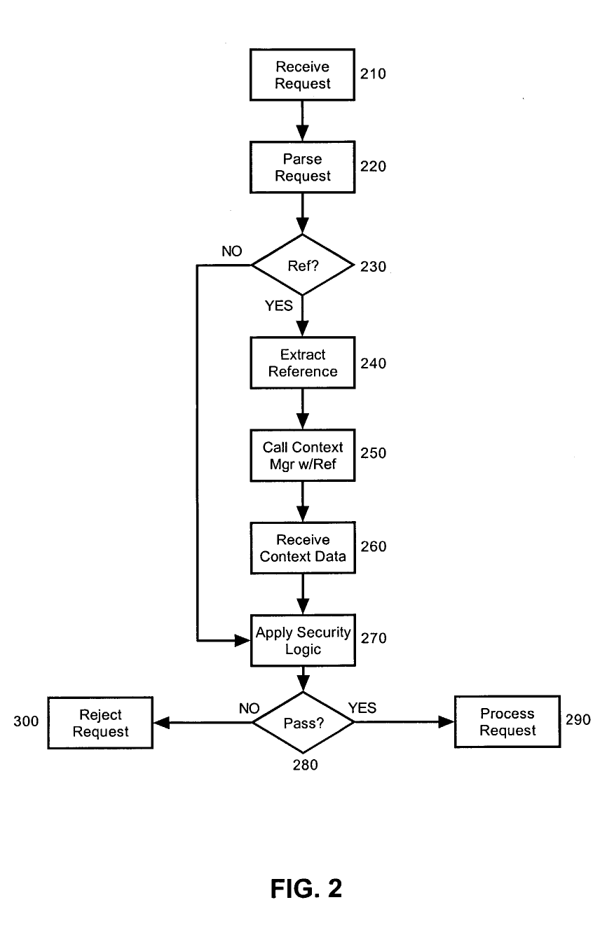

FIG. 2 is a flow chart illustrating a process for maintaining security context within the distributed, multi-protocol environment of FIG. 1. Beginning in block 210, a request can be received in an application service, or an application host such as an application server, grid host, Web services host or other such underlying infrastructure. In block 220, the request can be parsed according to the protocol defining the formatting of the request. In decision block 230, if a reference to security context can be identified within the request, in block 240 the reference can be extracted from the request. Otherwise, the request can be processed in block 270 without the benefit of security context data.

Where a reference has been identified within the request, however, in block 250 the context manager can be invoked along with the extracted reference. To that end, where the context manager itself merely is included as a remotely accessible application or application component, the context manager can be invoked in the same manner as any other hosted application or application component in the distributed environment. In any case, in block 260, the security context data can be retrieved from the context manager and in block 270 the security logic can be applied using the received security context data. If in decision block 280 the security logic permits access to the requested host or service, in block 290 the request can be processed. Otherwise, in block 300 the request can be rejected.

Notably, it will be recognized by the skilled artisan that the security context data can be provided to the application server in one of many forms, including one defined by the extensible markup language (XML). Still, it should be understood that some application servers will not enjoy a configuration for processing XML formatted security context data. In those instances, a translation process can be applied in which the retrieved security context data can be translated into a format appropriate for the particular application server. Such translation can occur either locally, in association with the application server, or remotely in a distributed fashion.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for maintaining security context data within a distributed environment, the method comprising the steps of:
identifying a context reference to the security context data within an application request;
retrieving the security context data from a remote source in the distributed environment by reference to said context reference; and,
passing said retrieved security context data to security logic coupled to a hosted application targeted by said application request.

2. The method of claim 1, further comprising the step of augmenting the security context data in said remote source with access data produced in consequence of accessing said hosted application targeted by said application request.

3. The method of claim 1, wherein said retrieving step comprises the step of invoking a remotely positioned context manager and calling a method in said remotely positioned context manager with said reference in order to retrieve the security context data.

4. The method of claim 1, wherein said retrieving step comprises the step of invoking a context manager service which has been one of locally positioned, remotely positioned, or centrally positioned and cached about the distributed environment.

5. The method of claim 1, further comprising the step of controlling access to said hosted application based upon said retrieved security context information.

6. A method for maintaining security context in a distributed environment, the method comprising the steps of:
programming at least one application server in the distributed environment to identify security context references within application requests received in said at least one application server;
coupling a context manager in the distributed environment to said programmed at least one application server; and,
configuring said programmed at least one application server to retrieve security context corresponding to identified security context references through said coupled context manager.

7. The method of claim 6, further comprising the step of disposing said context manager in a remotely positioned service host.

8. The method of claim 6, further comprising the steps of:
wrapping said context manager to form a grid service; and,
deploying said wrapped context manager in a grid host.

9. A machine readable storage having stored thereon a computer program for maintaining security context data within a distributed environment, the computer program comprising a routine set of instructions for causing the machine to perform the steps of:
identifying a context reference to the security context data within an application request;
retrieving the security context data from a remote source in the distributed environment by reference to said context reference; and,
passing said retrieved security context data to security logic coupled to a hosted application targeted by said application request.

10. The machine readable storage of claim 9, further comprising the step of augmenting the security context data in said remote source with access data produced in consequence of accessing said hosted application targeted by said application request.

11. The machine readable storage of claim 9, wherein said retrieving step comprises the step of invoking a remotely positioned context manager and calling a method in said remotely positioned context manager with said reference in order to retrieve the security context data.

12. The machine readable storage of claim 9, wherein said retrieving step comprises the step of invoking a context manager service which has been one of locally positioned, remotely positioned, or centrally positioned and cached about the distributed environment.

13. The machine readable storage of claim 9, further comprising the step of controlling access to said hosted application based upon said retrieved security context information.
